(19) United States
(12) Patent Application Publication
(10) Pub. No.: US 2002/0188937 A1
(43) Pub. Date: Dec. 12, 2002

(54) Network apparatus, network system and software updating method for network apparatus

(75) Inventors: Rodney Gordon Webster, Tokyo (JP); Yoshimichi Kudo, Tokyo (JP); Tadashi Kuwabara, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/057,479

(22) Filed: Oct. 19, 2001

(30) Foreign Application Priority Data
Jun. 6, 2001 (JP) 2001-170417

(51) Int. Cl. G06F 9/445

(52) U.S. Cl. 717/171

(57) ABSTRACT

A method is provided for updating system components of all apparatuses on a network capable of exchanging data between apparatuses to the optimum generation system components. A system update manager of FAV collects system information, and identification information and generation information of system update modules, from each apparatus. By using this information, the system update manager calculates an optimum system component combination for each apparatus connected to the network. In accordance with this calculation results, the system update manager reads necessary system update modules from each apparatus, and supplies necessary modules to each apparatus to update the system.

### BACKGROUND OF THE INVENTION

The present invention relates to a method of updating system software of a network apparatus on a network from another network apparatus in a network system having network apparatuses capable of reading data on the network, and to a network apparatus used in such a network system.

A communication system between AV apparatuses and information processing apparatuses and the like is now under development, in which system apparatuses are interconnected by IEEE1394 serial buses capable of data transmission through isochronous communications and control signal transmission through asynchronous communications. The 1394 serial bus is standardized in “IEEE Std 1394-1995” as “IEEE Standard for a High Performance Serial Bus”.

As a communication protocol to be used for mutual control of A/D apparatuses interconnected by 1394 serial buses, “Specification of the Home Audio/Video Interoperability (HAVi), Version 1.0” (hereinafter abbreviated to a HAVi specification) is made public. A method of providing code units for controlling its own apparatus is also made public in this HAVi specification.

Each apparatus in HAVi has “Self Describing Device Data” (hereinafter abbreviated to SSD data) for making information including its own functions open to other apparatuses. The details of SSD data are described in the HAVi specification. SSD data is stored in a configROM of each apparatus in a HAVi_Unit_Directory so that other apparatuses can refer to the SDD data via 1394 serial buses. This configROM has an address space capable of being referred to by using asynchronous communications of the 1394 serial bus, and its format is defined in “ISO/IEC 13213: 1994 Control and Status Register (CSR) Architecture for Microcomputer Buses (IEEE Std 1212-1994)” and “IEEE P1212 Draft 1.0, Draft Standard for a Control and Status Registers (CSR) Architecture for Microcomputer Buses, Oct. 18, 1999”. The data structure defined by these specifications as well as Directory and Leaf of vendor-specific Vendor_Info can be defined for the configROM.

In HAVi, AV apparatuses are classified into control apparatuses and controlled apparatuses. A “Base AV (BAV) Device” (hereinafter abbreviated to BAV) is a typical controlled apparatus and has SDD data and DCM which are uploaded to the control apparatus. A “Full AV (FAV) Device” (hereinafter abbreviated to FAV) is a typical control apparatus and has HAVi system components and Java execution environments.

If a network apparatus has its own network protocol software whose version is older than a nearby apparatus, a program portion not dependent upon OS is downloaded from the nearby apparatus to update it. This technique is made public in JP-A-2000-244513 (First Prior Art).

A network apparatus capable of updating the systems of all apparatuses of the same kind on the network is made public in JP-A-2000-194543 (Second Prior Art).

According to the First Prior Art, an apparatus to be updated acquires data newer than its own software from another apparatus connected to the network. According to the Second Prior Art, an apparatus having data for updating the system sends the data to another apparatus connected to the network. These approaches do not consider sufficiently the case that a number of apparatuses are connected to the network. Therefore, a conventional network system is associated with the following problems.

With the First Prior Art, the update process for an apparatus is performed in an apparatus unit (i.e., one apparatus after another). In order to update software of all apparatuses on the network, the same update process is required to be repetitively performed for all apparatuses. It takes time and a system load increases. With the Second Prior Art, in the system implemented by an object oriented language such as Java, even if a plurality of apparatuses have data for updating some of system components of other apparatuses, a partial update cannot be performed.

### SUMMARY OF THE INVENTION

It is an object of the invention to provide an efficient approach to updating and optimizing each system component which is a software module constituting a system of a network apparatus.

In order to achieve the above object, the invention adopts the following representative structure.

In a network system connecting a plurality of network apparatuses, a network apparatus (FAV) having the latest last update date and time collects update data detailed information and apparatus detailed information from other network apparatuses (FAV), and calculates optimum update data for each apparatus in accordance with the collected information. In accordance with the calculation results, necessary update data is acquired from each network apparatus, and transmitted to necessary network apparatuses to update the system components thereof.

Data for updating system components of each apparatus is stored in a configROM. A method can therefore be provided which updates system components of each apparatus in a HAVi network even if an external network cannot be connected.

According to another aspect of the invention solving the above problem, there is provided a software updating method for a network apparatus in a network system connecting a plurality of network apparatuses, comprising: a step of one network apparatus connected to a network acquiring system information of software installed in other network apparatuses; a step of acquiring generation information of system update modules from the system update modules, the system update modules being possessed by the other network apparatuses and used for updating software of the other network apparatuses; a step of obtaining optimum update data necessary for optimizing software of each network apparatus connected to the network, by using generation information contained in the system information and the generation information of the system update modules; and a step of acquiring system update modules containing the optimum update data from the network apparatuses having the optimum update data, and transmitting system update modules to a network apparatus necessary for optimizing the software to update the software by using the optimum update data.

### BRIEF DESCRIPTION OF THE DRAWINGS

FIG. 1 is a diagram showing an example of the structure of a network system using 1394 serial buses according to a first embodiment of the invention.

FIG. 2 is a diagram showing another example of the structure of a network system using 1394 serial buses according to a second embodiment of the invention.

FIG. 3 is a diagram showing another example of the structure of a network system using 1394 serial buses according to a third embodiment of the invention.

FIG. 4 is a diagram showing the structure of data and its additional information for updating system components according to an embodiment of the invention.

FIG. 5 is a diagram showing the structure of functions of a system and system information containing detailed information of each installed system component.

FIG. 6 is a flow chart illustrating a process of updating a system component of an apparatus on a network to which FAV having data for updating system components is connected, according to the first embodiment of the invention.

FIG. 7 is a flow chart illustrating a process of updating a system component of an apparatus on a network to which FAV inserted with a storage medium storing data for updating system components is connected, according to the second embodiment of the invention.

FIG. 8 is a flow chart illustrating a process of updating a system component of an apparatus on a network in which data for updating system components is downloaded from an external network, according to the third embodiment of the invention.

### DESCRIPTION OF THE EMBODIMENTS

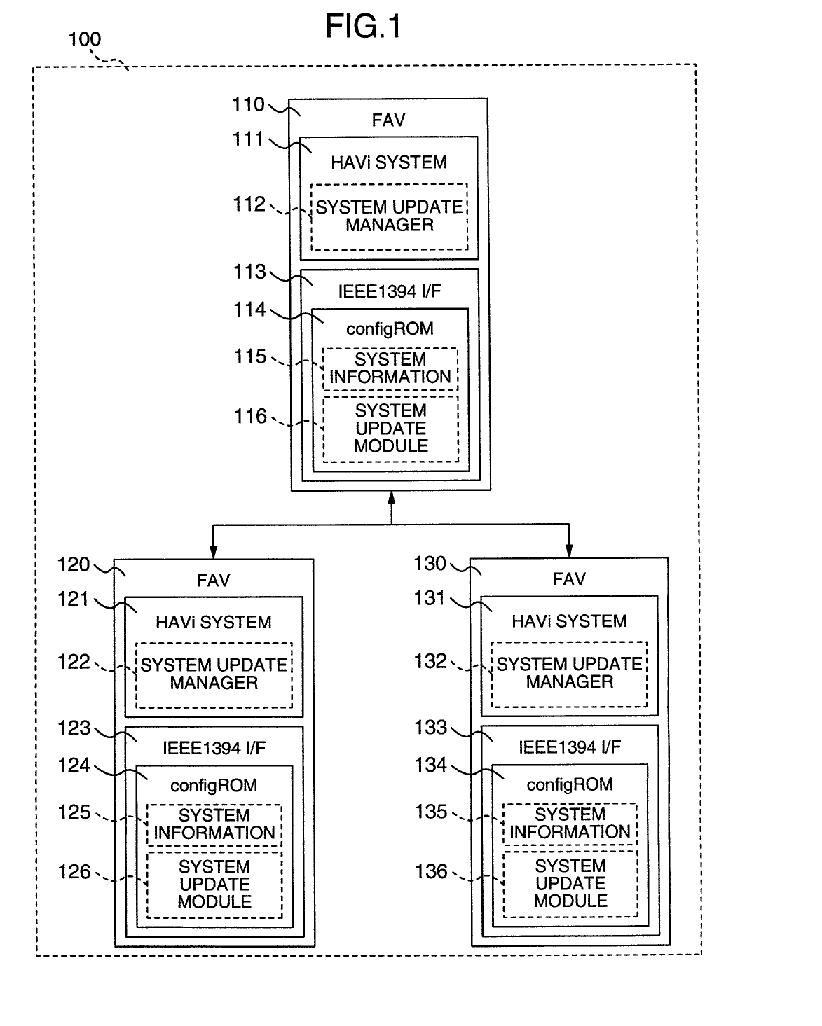

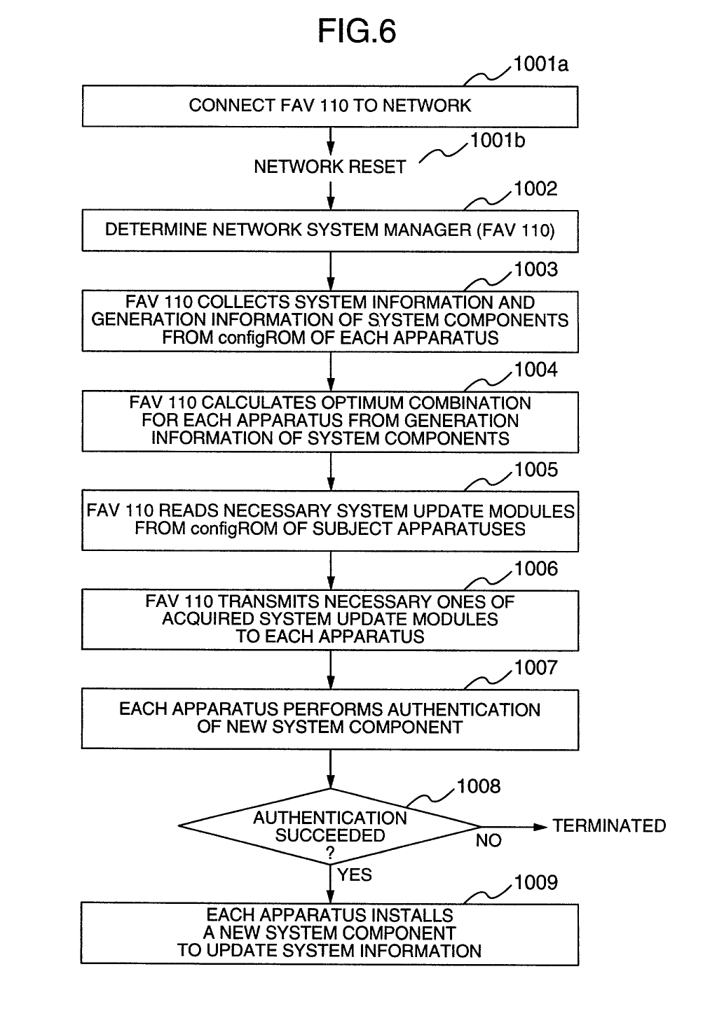

First, with reference to FIG. 6, a process will be described in which in a network system shown in FIG. 1, a system update manager 112 of FAV 110 operates as a network update manager, checks system update modules of its own, FAV 120 and FAV 130, and updates system components of all apparatuses by using optimum update data.

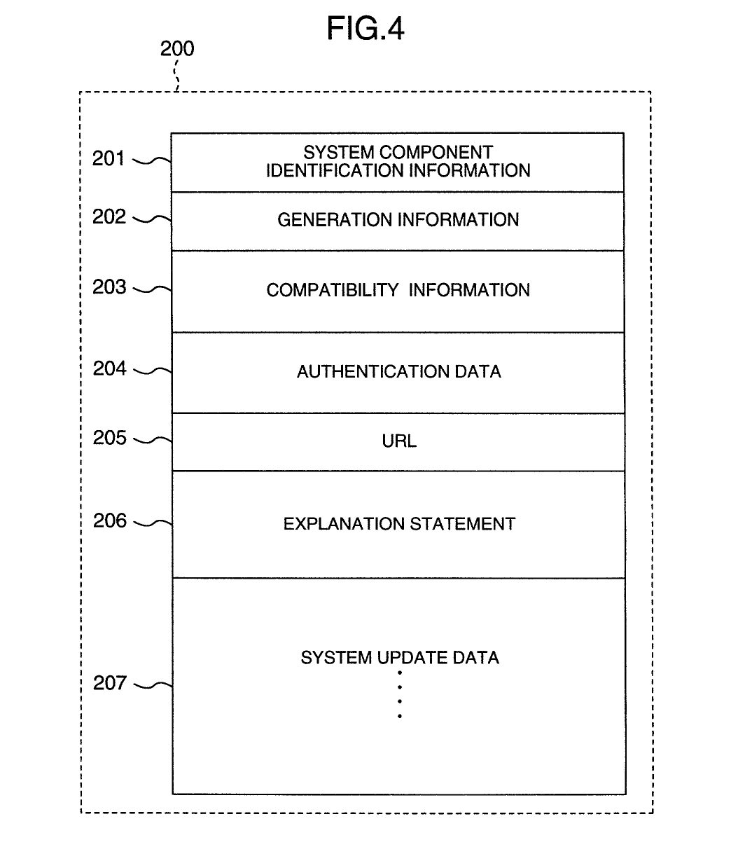

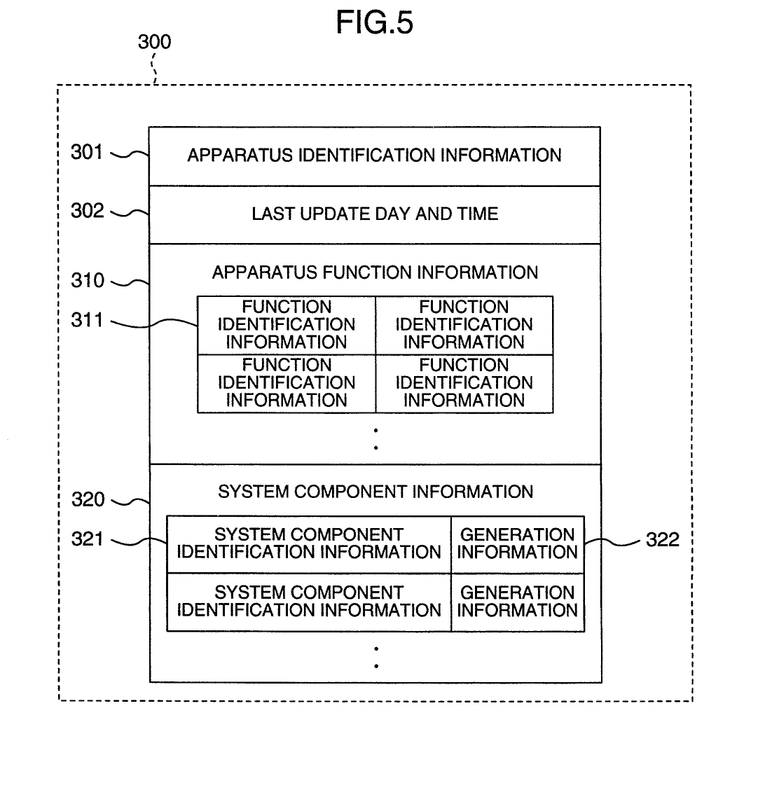

FIG. 1 is a diagram showing the structure of a HAVi network according to a first embodiment, and FIGS. 4 and 5 are diagrams showing an example of the structure of a configROM showing system information and system update modules.

Referring to FIG. 1, reference numeral 100 represents a HAVi network system, and reference numerals 110, 120 and 130 represent FAV's. The structure of each apparatus shown in FIG. 1 is as follows. Reference numerals 111, 121 and 131 represent HAVi systems of FAV 110, FAV 120 and FAV 130, respectively. Reference numerals 112, 122 and 132 represent system update managers, reference numerals 113, 123 and 133 represent IEEE1394 interfaces (hereinafter abbreviated to 1394 I/F). Reference numerals 114, 124 and 134 represent configROM's. In each configROM, reference numerals 115, 125 and 135 represent system information, and reference numerals 116, 126 and 136 represent system update modules.

New definitions other than those defined by the HAVi specification are as follows. The system update managers 112, 122 and 132 are system components which manage update of system components of apparatuses. A system update manager for collectively managing update of the whole network is called a network update manager which acquires update modules and their detailed information from other apparatuses and supplies the update modules and their detailed information to a third apparatus to update the system.

In FIG. 4, reference numeral 200 represents a system update module, reference numeral 201 represents system component identification information for identifying a corresponding system component, reference numeral 202 represents generation information, reference numeral 203 represents compatibility information which describes the compatibility of the functions of the apparatus relative to other system components for each generation, reference numeral 205 represents a URL used for acquiring latest system update modules via the Internet, reference numeral 206 represents an explanation statement which explains the updated contents, and reference numeral 207 represents system update data for updating a real system component.

In FIG. 5, reference numeral 300 represents system information, reference numeral 301 represents apparatus identification information for identifying the apparatus, and reference numeral 302 represents last update date and time indicating the day and time when the system of the apparatus was updated lastly. Reference numeral 310 represents apparatus function information of hardware and software functions provided by the apparatus, and reference numeral 311 represents function identification information for identifying each function. Reference numeral 320 represents system component information of an installed system component, reference numeral 321 represents system component identification information of a system component, and reference numeral 322 represents generation information of a current generation of each system component.

FIG. 6 is a flow chart illustrating a process of updating a system component of an apparatus on the network. With reference to FIG. 6, the update process of updating each apparatus connected to the network will be described, in which the system update manager 112 of FAV 110 becomes a network update manager.

First, at Step 1001a, FAV 110 is connected to the network 100 so that a network reset occurs (Step 1001b).

Next, at Step 1002, FAV 110, FAV 120 and FAV 130 check the last update date and time 302 from the system information 115, 125 and 135 stored in the configROM's 114, 124 and 134. The latest updated apparatus becomes a network update manager. If there are a plurality of same last date and time sets, the apparatus having a largest number corresponding to the apparatus identification information 301 is selected. It is herein assumed that the system update manager 112 of FAV 110 is selected as the network update manager.

At Step 1003, the system update manager 112 of FAV 110 as the network update manager collects the system information 115, 125 and 135 from the configROM's 114, 124 and 134 of the apparatuses, and collects the system component identification information 201, generation information 202 and compatibility information 203 from the system update modules 116, 126 and 136.

At Step 1004, in accordance with the information collected at Step 1003, the system update manager 112 of FAV 110 calculates an optimum combination for each apparatus. This calculation is performed with the highest priority that system components to be installed have a newer generation than the presently installed system components and that there is compatibility with other system components (already installed system components and installable system components). Only the system components supported by the functions in the apparatus function information 310 are installed.

At Step 1005, in accordance with the calculation results at Step 1004, the system update manager 112 of FAV 110 reads necessary system update modules from the configROM's 114, 124 and 134 of the apparatuses.

At Step 1006 the system update manager 112 of FAV 110 transmits the system update modules acquired at Step 1005 to each apparatus necessary for updating.

At Step 1007, upon reception of the system update module, each apparatus performs authentication by using the stored authentication data 204.

At Step 1008, if the authentication succeeds, the flow advances to Step 1009, whereas if not, the process is terminated.

At Step 1009, at the apparatus which received the system update module and succeeded the authentication, the system update manager installs a new system component.

The description has been made for the operation of updating a system component of an apparatus on the network according to the first embodiment.

Next, a second embodiment of the invention will be described.

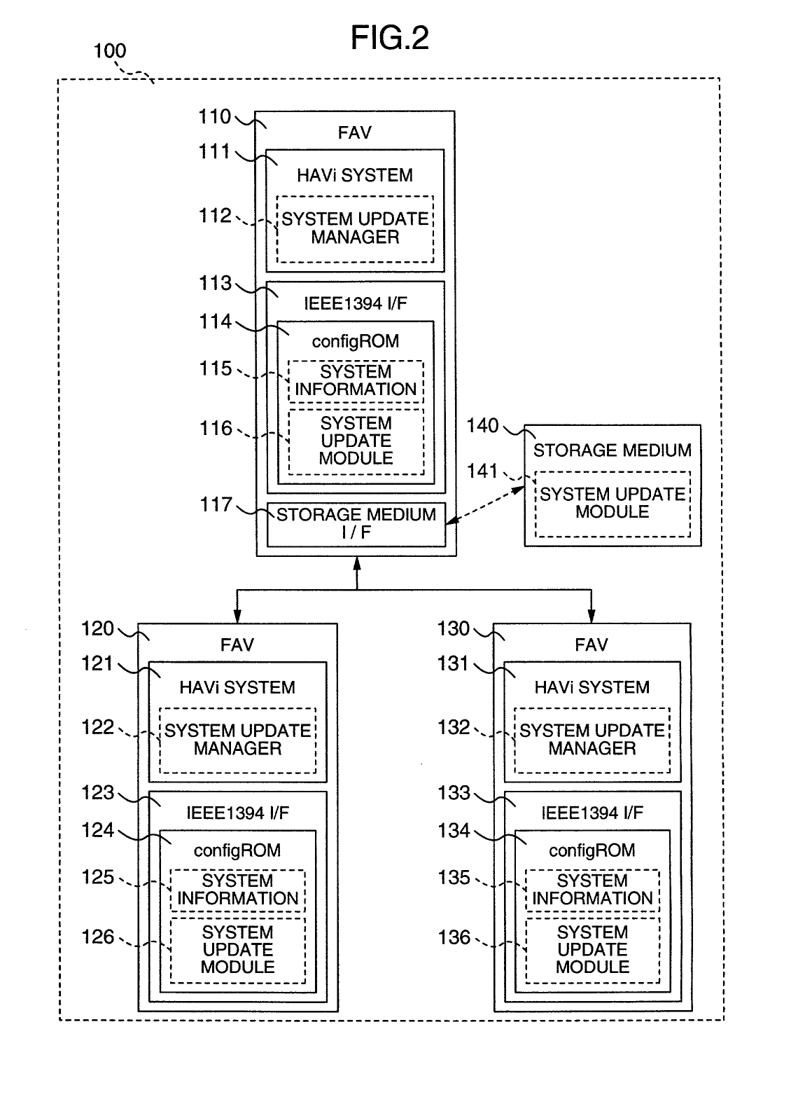

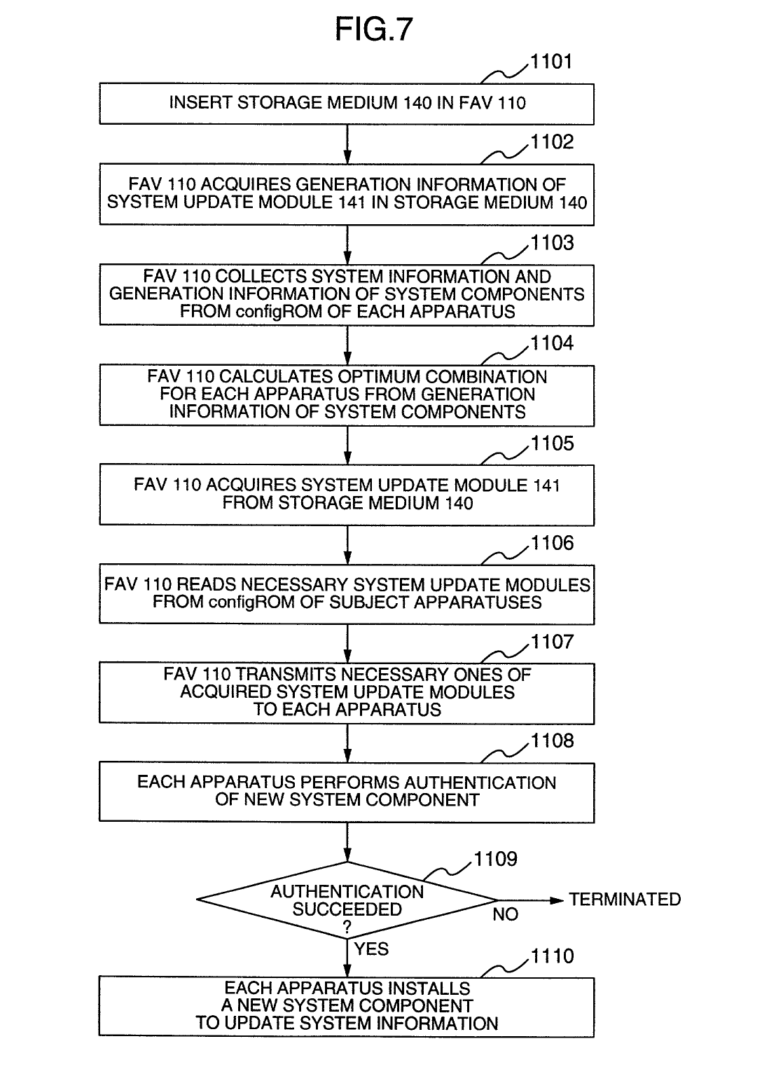

FIG. 2 is a diagram showing the structure of a HAVi network according to the second embodiment, and FIG. 7 is a flow chart illustrating a process of updating a system component of an apparatus on a network by using a system update module stored in a removable storage medium.

In FIG. 2, reference numeral 100 represents a HAVi network system having the structure similar to the network structure shown in FIG. 1. Different points of the structure of FAV 110 are a storage medium interface 117 (hereinafter abbreviated to a storage medium I/F) 117, a removable storage medium 140 and a system update module 141 stored in the storage medium 140.

Next, with reference to FIG. 7, a process of updating a system of an apparatus on the network by using a system update module stored in the storage medium 140 will be described, the process being executed by the system update manager 112 of FAV 110.

At Step 1101, the storage medium 140 is inserted into FAV 110.

At Step 1102, the system update manager 112 of FAV 110 becomes a network update manager and acquires the system component identification information 201, generation information 202 and compatibility information 203 from the system update module 141 stored in the storage medium 140.

At Step 1103, the system update manager 112 of FAV 110 collects the system information 115, 125 and 135 from the configROM's 114, 124 and 134 of the apparatuses, and collects the system component identification information 201, generation information 202 and compatibility information 203 from the system update modules 116, 126 and 136.

At Step 1104, in accordance with the information collected at Steps 1102 and 1103, the system update manager 112 of FAV 110 calculates an optimum combination for each apparatus. This calculation is performed with the highest priority that system components to be installed have a newer generation than the presently installed system components and that there is compatibility with other system components (already installed system components and installable system components). Only the system components supported by the functions in the apparatus function information 310 are installed.

At Step 1105, in accordance with the calculation results at Step 1104, the system update manager 112 of FAV 110 reads system update modules 141 from the storage medium 140.

At Step 1106, in accordance with the calculation results at Step 1104, the system update manager 112 of FAV 110 reads necessary system update modules from the configROM's 114, 124 and 134 of the apparatuses.

At Step 1107, the system update manager 112 of FAV 110 transmits the system update modules acquired at Steps 1105 and 1106 to each apparatus necessary for updating.

At Step 1108, upon reception of the system update module, each apparatus performs authentication by using the stored authentication data 204.

At Step 1109, if the authentication succeeds, the flow advances to Step 1110, whereas if not, the process is terminated.

At Step 1110, at the apparatus which received the system update module and succeeded the authentication, the system update manager installs a new system component.

The description has been made for the operation of updating a system component of an apparatus on the network by using the storage medium, according to the second embodiment.

Next, a third embodiment of the invention will be described.

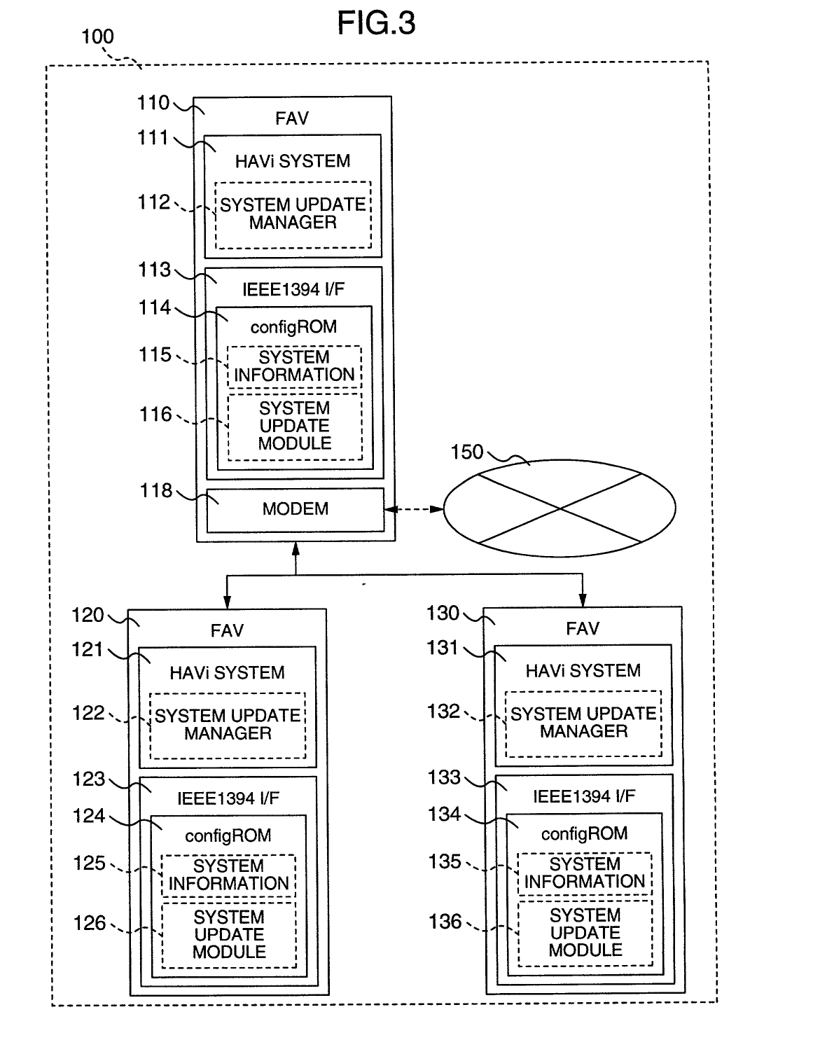

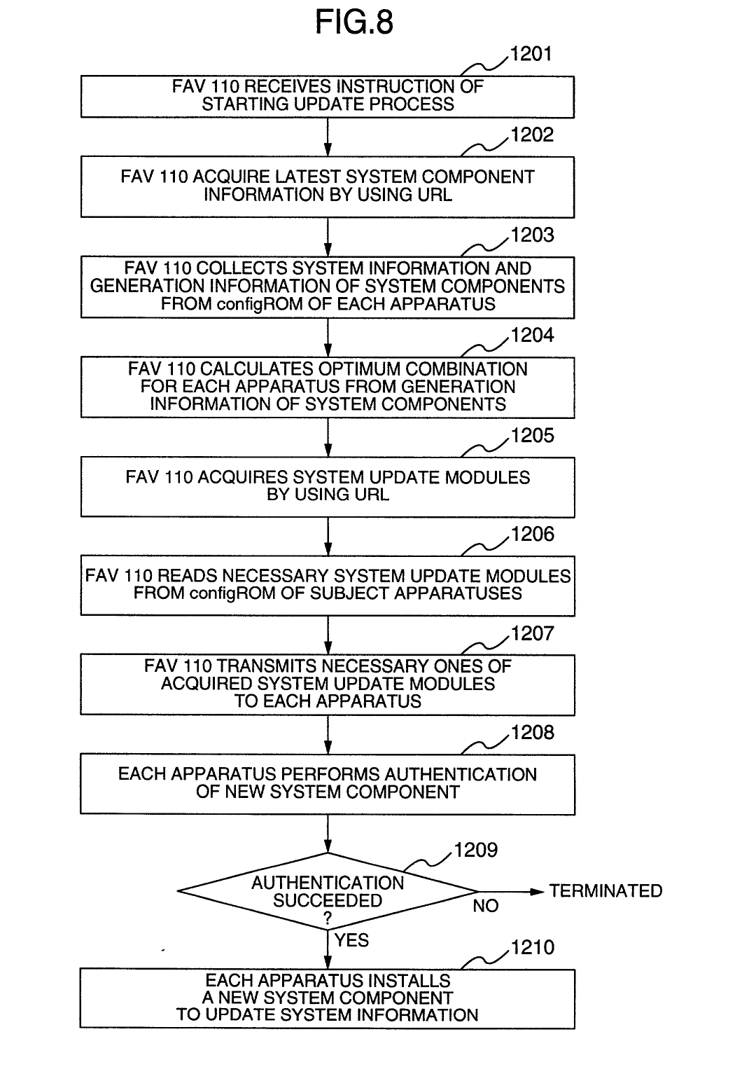

FIG. 3 is a diagram showing the structure of a HAVi network according to the third embodiment, and FIG. 8 is a flow chart illustrating a process of updating a system component of an apparatus on a network by downloading a system update module from the Internet.

In FIG. 3, reference numeral 100 represents a HAVi network system having the structure similar to the network structure shown in FIG. 1. Different points of the structure of FAV 110 are a modem 118 and a network (the Internet) 150 connected via the modem 118.

Next, with reference to FIG. 8, a process of updating a system of an apparatus on the network by downloading a system update module from the Internet will be described, the process being executed by the system update manager 112 of FAV 110.

At Step 1201, FAV 110 receives an instruction to start the update process from a user.

Next, at Step 1202, the system update manager 112 of FAV 110 acquires latest system component information by using a URL.

At Step 1203, the system update manager 112 of FAV 110 collects system information 115, 125 and 135 from the configROM's 114, 124 and 134 of the apparatuses, and collects the system component identification information 201, generation information 202 and compatibility information 203 from the system update modules 116, 126 and 136.

At Step 1204, in accordance with the information collected at Steps 1202 and 1203, the system update manager 112 of FAV 110 calculates an optimum combination for each apparatus. This calculation is performed with the highest priority that system components to be installed have a newer generation than the presently installed system components and that there is compatibility with other system components (already installed system components and installable system components). Only the system components supported by the functions in the apparatus function information 310 are installed.

At Step 1205, in accordance with the calculation results at Step 1204, the system update manager 112 of FAV 110 acquires system update modules by using the URL.

At Step 1206, in accordance with the calculation results at Step 1204, the system update manager 112 of FAV 110 reads necessary system update modules from the configROM's 114, 124 and 134 of the apparatuses.

At Step 1207, the system update manager 112 of FAV 110 transmits the system update modules acquired at Steps 1205 and 1206 to each apparatus necessary for updating.

At Step 1208, upon reception of the system update module, each apparatus performs authentication by using the stored authentication data 204.

At Step 1209, if the authentication succeeds, the flow advances to Step 1210, whereas if not, the process is terminated.

At Step 1210, at the apparatus which received the system update module and succeeded the authentication, the system update manager installs a new system component.

The description has been made for the operation of updating a system component of an apparatus on the network by acquiring the update data from the Internet, according to the third embodiment.

Connection to the network providing update data is not limited only to using a modem, but other access/reception methods may also be used such as the ISDN, a cable model, and a satellite broadcast receiver. In this embodiment, although the update process starts upon reception of a user's instruction, other methods may be used such as receiving an instruction via an external network, and performing the update process at a constant interval.

In the above embodiments, although the network update manager transmits the system update modules to each apparatus necessary for updating, each apparatus may acquire necessary system update modules by accessing a notified site. Further, the apparatus received a new system update module may supply it to another apparatus.

Also in the above embodiments, although each apparatus has a system update module and a system update manager, each system update manager may have a plurality of system update modules or may not have a system update modules, and each apparatus may have only a system update manager or only a system update module.

Also in the above embodiments, although a system component of HAVi is updated, software (e.g., VTR software) of another apparatus connected to the network may be updated.

In the above-described system, information of a system update module to be updated may be made open to users to allow them to determine whether update is to be performed. In such a case, approximately similar to the above embodiments, prior to the update process, the detailed information stored in a system update module is presented to users to allow them to determine whether update is to be performed. The detailed information may be generation information, explanation statement, compatibility information and the like.

As described so far, according to the invention, even if a component of system software for controlling an apparatus is revised to have a new generation, the old system component of the apparatus can be replaced by the new generation system component. It is not necessary to connect the Internet in order to update the system component. Since the update is performed in the system component unit, it is possible to deal with different types of apparatuses, reduce a load of the network, and maximize compatibility stability between system components.

What is claimed is:

1. A software updating method for a network apparatus in a network system connecting a plurality of network apparatuses, comprising:
a step of one network apparatus connected to a network acquiring system information of software installed in other network apparatuses;
a step of acquiring generation information of system update modules from the system update modules, the system update modules being possessed by the other network apparatuses and used for updating software of the other network apparatuses;
a step of obtaining optimum update data necessary for optimizing software of each network apparatus connected to the network, by using generation information contained in the system information and the generation information of the system update modules; and
a step of acquiring system update modules containing the optimum update data from the network apparatuses having the optimum update data, and transmitting system update modules to a network apparatus necessary for optimizing the software to update the software by using the optimum update data.

2. A software updating method for a network apparatus in a network system connecting a plurality of network apparatuses, comprising:
a step of one network apparatus connected to a network acquiring system information from other network apparatuses, the system information containing system component information constituted of system component identification information and generation information of software installed in each of the other network apparatuses;
a step of acquiring system component identification information and generation information of system update modules from the system update modules, the system update modules being possessed by the other network apparatuses and used for updating software of the other network apparatuses;
a step of obtaining optimum update data necessary for optimizing software of each network apparatus connected to the network, by using the system information and the system component identification information and generation information of the system update modules; and
a step of acquiring system update modules containing the optimum update data from the network apparatuses having the optimum update data, and transmitting system update modules to a network apparatus necessary for optimizing the software to update the software by using the optimum update data.

3. A software updating method according to claim 1, wherein:
the software is optimized by updating the software to latest generation software by using the system information and the generation information of the system update modules.

4. A software updating method according to claim 2, wherein:
the software is optimized by updating the software to latest generation software by using the system information and the system component identification information of the system update modules.

5. A software updating method according to claim 2, wherein:
the system information contains also apparatus function information made of function identification information describing hardware and software functions of each network apparatus;
the system update module also contains compatibility information between hardware and other software; and
the software is optimized by updating the software by further referring to the apparatus function information and compatibility information.

6. A software updating method according to claim 2, wherein:
the system update module also contains information for acquiring latest system update modules from an external network; and
the system update module is acquired also from the external network.

7. A software updating method according to claim 2, wherein:
the software to be updated includes a plurality of components, the update data updates only some components of the software, and the system update module contains compatibility information between the update data and the other components of the software.

8. A software updating method according to claim 1, wherein:
when a new network apparatus is connected to the network, an update process for the software is executed.

9. A software updating method according to claim 2, wherein:
when a new network apparatus is connected to the network, an update process for the software is executed.

10. A software updating method according to claim 2, wherein:
the system information possessed by each network apparatus contains the last update date and time when the software was updated lastly; and
if the network has two or more network apparatuses capable of executing an update process for the software, the network apparatus having the latest last update date and time becomes a manager to execute the update process.

11. A software updating method according to claim 1, wherein:
the system update module also contains an explanation statement of update contents; and
the explanation statement is presented to a user to allow the user to determine whether update is performed by using the system update module.

12. A network apparatus in a network system connecting a plurality of network apparatuses, wherein: system information of software installed in each network apparatus connected to a network is acquired from each network apparatus;
generation information of system update modules is acquired from the system update modules, the system update modules being possessed by each of other network apparatuses and used for updating software of the other network apparatuses;
optimum update data necessary for optimizing software of each network apparatus connected to the network is obtained by using generation information contained in the system information and the generation information of the system update modules; and
system update modules containing the optimum update data are acquired from the network apparatuses having the optimum update data, and the system update modules are transmitted to a network apparatus necessary for optimizing the software to update the software by using the optimum update data.

13. A network apparatus in a network system connecting a plurality of network apparatuses, wherein:
system information is acquired from each of the network apparatuses connected to a network, the system information containing system component information constituted of system component identification information and generation information of software installed in each of the network apparatuses;
system component identification information and generation information of system update modules are acquired from the system update modules, the system update modules being possessed by other network apparatuses and used for updating software of the other network apparatuses;
optimum update data necessary for optimizing software of each network apparatus connected to the network is obtained by using the system information and the system component identification information and generation information of the system update modules; and
system update modules containing the optimum update data are obtained from the network apparatuses having the optimum update data, and the system update modules are transmitted to a network apparatus necessary for optimizing the software to update the software by using the optimum update data.

14. A network apparatus according to claim 12, wherein:
the software is optimized by updating the software to latest generation software by using the system information and the generation information of the system update modules.

15. A network apparatus according to claim 13, wherein:
the software is optimized by updating the software to latest generation software by using the system information and the system component identification information of the system update modules.

16. A network apparatus according to claim 13, wherein:
the system information contains also apparatus function information made of function identification information describing hardware and software functions of each network apparatus;
the system update module also contains compatibility information between hardware and other software; and
the software is optimized by updating the software by further referring to the apparatus function information and compatibility information.

17. A network apparatus according to claim 12, wherein:
the software of the subject network apparatus is optimized by using the system update module.

18. A network apparatus according to claim 12, wherein:
the system update module is acquired also from a removable storage medium.

19. A network apparatus according to claim 12, wherein:
the system update module also contains information for acquiring a latest system update module from an external network and the system update module is acquired also from the external network.

20. A network apparatus in a network system connecting a plurality of network apparatuses, wherein:
the network apparatus has system information containing system component information constituted of system component identification information and generation information of software installed in the subject network apparatus, and a system update module to be used for updating software of the other network apparatuses; and
the system information and system update module are supplied to the other network apparatuses connected to a network, a system update module for optimizing the software of the subject network apparatus is received from the other network apparatuses connected to the network, and the software of the subject network apparatus is updated by using optimum update data contained in the system update module.

21. A network apparatus according to claim 20, wherein:
the system update module contains authentication data; and
the optimum update data and corresponding authentication data are received, the optimum update data is authenticated by using the corresponding authentication data, and whether update is performed or not is determined by authentication results.

22. A network apparatus according to claim 20, wherein:
the system update module received from one of the other network apparatuses is presented to another of the other network apparatuses connected to the network.

23. A network apparatus according to claim 20, wherein:
the software to be updated has a plurality of separated components; and
the system update module updates only some components of the software, and the system update module contains compatibility information between the update data and the other components of the software.

24. A network apparatus according to claim 20, wherein:
information of a network apparatus having the system update module for optimizing the software of the subject network apparatus is received from the other network apparatuses connected to the network, and the subject network apparatus acquires the system update module.

25. A network system connecting a plurality of network apparatuses, wherein:
one network apparatus connected to a network acquires system information from other network apparatuses, the system information containing system component identification information and generation information of software installed in each of the other network apparatuses;
system component identification information and generation information of a system update module are acquired from the system update module, the system update module being possessed by each of the other network apparatuses and used for updating software of the other network apparatuses;
optimum update data necessary for optimizing the software of each network apparatus connected to the network is obtained by using the system information and the system component identification information and generation information of the system update module; and
system update modules containing the optimum update data are acquired from the network apparatuses having the optimum update data, and transmitted to a network apparatus necessary for updating the software to update the software by using the optimum update data.
